(19) United States
(12) Patent Application Publication
(10) Pub. No.: US 2006/0051599 A1
(43) Pub. Date: Mar. 9, 2006

(54) Coatings for articles used with molten metal

(76) Inventors: Mahnaz Jahedi, Victoria (AU); Stefan Gulizia, Victoria (AU)

Correspondence Address: DENNISON, SCHULTZ, DOUGHERTY & MACDONALD, 1727 KING STREET, SUITE 105, ALEXANDRIA, VA, 22314, US

(21) Appl. No.: 10/518,540

(22) PCT Filed: Jun. 30, 2003
(86) PCT No.: PCT/AU03/00834

§ 371 Date: Apr. 26, 2005

(30) Foreign Application Priority Data
Jul. 1, 2002 (AU) PS 3292

(51) Int. Cl. C03B 29/00; B05D 5/00; B32B 15/04; B32B 9/00; B32B 19/00

(52) U.S. Cl. 428/469; 427/258; 156/89.11; 428/472; 428/701; 428/702; 428/698

(57) ABSTRACT

An improved multilayer coating for use on molten metal holding and transfer apparatus, the coating including a bound layer applied directly to the surface of molten metal holding and transfer apparatus, and a porous layer of ceramic material produced by co-deposition of a powder of said ceramic material and a powder of a suitable organic polymer material and, after the co-deposition, heating of said polymer material to thermally decompose the polymer material and form the porous layer. The bond layer preferably is formed of a metallic, intermetallic or composite particulate materials. The metal component may be in the metallic, intermetallic, oxide, clad or alloyed form consisting of any one or more of the metal components selected from the group of Mo, Ni, Al, Cr, Co, Y and W and may be in combination with yttria, alumina, zirconia, boron, carbon and have a particle size in the range of 5 to 250 m, typically 40 to 125 m. The bond layer preferably has a thickness of 5 to 300 m with a substantially uniform coating layer being provided over the surfaces to have the porous ceramic coat applied.

### TECHNICAL FIELD

This invention relates to coatings for articles used in handling molten metal and in particular relates to articles used for transferring, stirring and holding molten metal.

### BACKGROUND OF THE INVENTION

In many molten metal handling operations, articles used to handle molten metal are often provided with coatings to protect the surface of the articles from the erosive and corrosive effects of the molten metal. In particular, metallic and ceramic coatings have been used for a many years to change the surface performance of the refractory materials in contact with metal troughs, launders, ladles, skimming tools and siphon tubes. All of these articles are in contact with flowing molten metal, thus exposing the coatings to not only corrosive attack from the molten metal but also erosion from the metal drag across the surface of the coating. The thermally insulating nature of the coating also prevents temperature loss of the molten metal.

One possible solution to the erosion problem is simply to provide a thicker coating. Unfortunately thicker coatings are prone to delamination and typically have less strength than thin coatings due to micro cracking or low cohesive bonding.

Another problem with thicker coatings arises from the thermal expansion difference between the substrate and the coating. Stresses arising from these thermal expansion differences become more pronounced with thicker coatings as they go through temperature changes leading to spalling of the thicker coatings. Because of the delamination problems and thermal expansion mismatches, the ability to effectively thermally insulate the metal articles, wear resistance and service life is adversely affected and thicker ceramic coatings are not extensively used for metal transfer and holding apparatus.

By referring to the coatings as “ceramic based” the term “ceramic” was used in its art recognised sense as being inorganic, non-metallic materials processed or consolidated at higher temperature” (McGraw-Hill Encyclopaedia of Science and Technology 1994). The classes of materials generally considered to be ceramics include oxides, nitrides, borides, silicides and sulfides. Intermetallic compounds such as aluminates and beryllides are also considered as “ceramics” as are phosphides, antimonides and arsenides.

In PCT/AU00/00239 an improved die coating for use on the surface of a mould or die component contacted by molten metal in low pressure or gravity die casting was disclosed. In that reference, the coating included a porous layer of ceramic material produced by co-deposition, using a thermal spraying procedure, of a powder of the material and a powder of a suitable organic polymer material and, after the co-deposition, heating of the polymer material (in an oxidizing atmosphere) to cause its decomposition and removal.

That invention also provided a process for providing a die coating on such surface of a metal mould or die component wherein an initial coating of organic polymer material and ceramic material was formed on the surface by co-deposition of powders of the materials by a thermal spraying procedure, and the initial coating was heated so as to remove the polymer material and leave a porous coating of the ceramic material. In low pressure and gravity die casting, the molten metal does not continuously travel across the surface of the mould, and so the effects of erosion and wear resistance are not considered to be a significant consideration.

The known die coating technology typically involved the use of a water-based suspension of ceramic particles in a water-based binder, most commonly sodium or potassium silicate. Coating mixtures of this type needed to be properly stored and mixed. The coating was applied to the prepared surface of a die component using a pressurised air spray gun. For this, the die component was preheated, typically from about 150 to 220° C., such that water was evaporated from the die surface, enabling the binder to polymerise and bond the ceramic particles together and to the die surface.

However in liquid metal transport and holding applications, there is significantly more metal drag on the coating. Thus, thermal mismatches and lamination flow effects, play a much greater role in the service life and wear resistance of the coating.

The applicants have found that coating compositions as disclosed in this PCT patent application surprisingly can be extended beyond the use in dies described in that invention to liquid metal transport and holding articles.

### SUMMARY OF THE INVENTION

Accordingly, the invention provides in one form an improved multilayer coating for use on molten metal holding and transfer apparatus, the coating including a bond layer applied directly to the surface of molten metal holding and transfer apparatus, and a porous layer of ceramic material produced by co-deposition of a powder of said ceramic material and a powder of a suitable organic polymer material and, after the co-deposition, heating of said polymer material to thermally decompose the polymer material and form the porous layer.

The applicants have found that the application of a bond layer to the surface of the molten metal and holding apparatus prior to the application of the porous layer of ceramic material, reduces the thermal expansion mismatch between the porous ceramic coating and the metal substrate, the application of this layer greatly enhances the physical bond strength of the porous ceramic layer.

During use of the coated molten metal holding and transfer apparatus, the thermal mismatch between the substrate and the ceramic layer can result in fine cracks appearing which initially can go undetected. This greatly exposes the metal substrate to oxidation and erosion. The applicants have found that by providing a bond layer, not only is the thermal expansion mismatch reduced, substrate damage caused by oxidation and corrosion is also substantially reduced.

The bond layer preferably is formed of a metallic, intermetallic or composite particulate materials. The bond layer is formed from a particulate material applied to the surface of the metal surface of the transport, stirring or holding apparatus. The bond coat layer can be applied by a thermal spray process such as vacuum plasma spray (VPS), atmospheric plasma spray (APS), combustion flame spraying and hyper velocity oxyfuel (HVOF) spray processes.

The metal in the bond layer may be in the metallic, intermetallic, oxide, clad or alloyed form consisting of any one or more of the metal components selected from the group of Mo, Ni, Al, Cr, Co, Y and W and may be in combination with yttria, alumina, zirconia, boron, carbon and have a particle size in the range of 5 to 250 μm, typically 40 to 125 μm. The bond layer preferably has a thickness of 5 to 300 μm with a substantially uniform coating layer being provided over the surfaces to have the porous ceramic coat applied.

After the bond layer has been applied to the metal surface of the transport, stirring or holding apparatus, a ceramic and polymer powder is deposited. This ceramic and polymer powder is then heated to thermally decompose the polymer powders to leave a porous ceramic layer on the bond layer.

The ceramic powder making up the porous layer may be selected from at least one metal compound such as oxides, nitrides, carbides and borides, preferably from the group comprising alumina, titania, silica, stabilised or partially stabilised zirconia, silicon nitride, silicon carbide, and tungsten carbide.

Alternatively, the ceramic powder may be at least one mineral compound selected from the group of clay minerals, hard rock ore and heavy mineral sands such as those of ilmenite, rutile and/or zircon.

The organic polymer powder may be formed from a thermoplastic material, such as polystyrene, styrene-acrylonitrile, polymethacrylates, polyesters, polyamides, polyamide-imides and PTFE.

Preferably the ceramic and polymer powders are of relatively narrow size spectrum and preferably in the range 20 μm-400 μm.

The ceramic and polymer particles which are used to form the porous ceramic layer are of particle sizes not more than about 300 μm and not less than about 5 μm.

The porous coating may have a thickness of from about 50 to 600 μm and a porosity of up to 70% depending on its application.

More preferably the porous coating has a thickness of from about 100 to about 400 μm. The insulating properties of the coating are a function of the coating thickness, the thermal conductivity of the ceramic as well as the porosity of the coating.

The invention provides a process of providing a coating on the surface of an article that comes into contact with molten metal, wherein an initial coating is applied to the surface of the article and a ceramic insulating layer of an organic polymer material and ceramic material is formed on the surface by co-deposition of powders of the materials and the coating is heated preferably to a temperature to decompose and remove the polymer material and leave a porous layer of the ceramic material. This temperature is above the thermal decomposition temperature of the polymer and up to 550° C. As the articles to be coated are metal, typically mild steel or cast iron, it is desirable to avoid temperatures above 600° C., as such elevated temperatures have an effect on the tempering, microstructure and properties of the metal components. In fact, above 900° C., the steel dies undergo an austenitic phase transformation which changes hardness and causes distortion of the metal components.

In order to produce a very smooth surface finish, an outermost layer of fine ceramic material without polymer can be applied. This is particularly useful where the coating is more porous.

In an alternative form, the invention provides an improved coating for use on metal articles that are in contact with molten metals. The improved coating including a bond layer, a porous layer of ceramic material produced by co-deposition of a powder of said ceramic material and a powder of a suitable organic polymer material and, after the co-deposition, heating preferably to a temperature of up to 550° C. of said polymer material to cause its removal.

### DETAILED DESCRIPTION OF THE INVENTION

The invention will now be described by reference to the following non-limiting example.

To reduce the thermal expansion mismatch between metal article and the coating, a bond layer such as that described below was applied between the coating and the metal surface of the transport and holding apparatus. The bond layer also served to enhance the adhesive strength of the coating.

The bond layer powder that was particularly effective was a Metco 480-NS grade fully alloyed spheroidal, gas atomised Nickel 95% Aluminium 5% for which the data sheet indicated a particle size range of not more than 90 μm and not less than 45 μm. Other commercially available bond coats and also mixture of metals and ceramic bond coats can be used.

In particular, the applicants have found that the coating compositions may be usefully applied to transfer troughs, launders, ladles, skimming tools and siphon tubes.

### EXAMPLE 1

A Bond layer was applied to a prepared metal surface with a Miller Thermal SG 100 Plasma Spray Torch thermal spray unit. The bond coat powder was a Metco 480-NS grade fully alloyed spheroidal, gas atomised Nickel 95% Aluminium 5% for which the data sheet indicated a particle size range of not more than 90 μm and not less than 45 μm. The process settings used were as follows:—
Voltage: 33
Current: 650
Plasma Gases: Argon at 50 psi & Helium at 50 psi
Powder Feed Rate: 1.5 RPM at 35 psi
Spray Distance: 100 mm

Ceramic powder and polymer powder were mixed and subjected to a thermal spraying to form a co-deposited coating on a ladle used for transferring molten metal to a die cavity defining the surface of a low pressure metal die cast component. The ceramic powder was Metco 210 (NS/NS-1/NS-1-G) grade zirconia stabilised by 24% magnesium oxide for which the data sheet indicated a particle size range of not more than 90 μm and not less than 11 μm, a melting point of 2140° C. and a density of 4.2 g/cm³. The polymer powder was of polymer supplied by Sulzermetco which had been ground to −150 +45 μm (−100 +325). The powder mixture of MgO(24%) ZrO₂/polystyrene contained 15% volume percent (3 wt %) of polymer.

The co-deposition of the powder mixture was performed using a Miller Thermal SG 100 Plasma Spray Torch and a Miller Thermal powder feeder, under the following settings:
Voltage: 34
Current: 750
Plasma Gases: Argon at 50 psi & Helium at 50 psi
Powder Feed Rate: 2.88 (rpm) at 35 psi
Spray Distance: 100 mm

Following co-deposition of the blended powders, the deposited coating was heated to 450° C. for one hour at atmospheric conditions to cause the polymer to decompose. Polymer decomposes fully at 320 to 350° C. in air. The porous, stabilised zirconia coating resulting from removal of the polymer by de-composition was found to comprise an excellent coating having good wear resistance and adequate thermal insulation enabling it to withstand the impingement of molten metal coating also exhibited a low heat transfer coefficient, such that solidification of molten metal during such molten metal handling operations was able to be delayed until molten metal had been transferred.

1. A multilayer coating for use on molten metal holding, stirring and transfer apparatus, the coating including a bond layer applied directly to the surface of the molten metal holding and transfer apparatus and a porous layer of ceramic material produced by co-deposition of a powder of said ceramic material and a powder of a suitable organic polymer material and, after the co-deposition, heating of said polymer material to cause its removal.

2. The multilayer coating wherein the bond layer is formed from a particulate material having at least one metal component in a metallic, intermetallic, oxide, clad or alloyed form.

3. The coating of claim 2 where at least one metal component in the bond layer is selected from the group consisting of molybdenum, nickel, aluminium, chromium, cobalt, yttrium and tungsten.

4. The coating of claim 3 wherein the at least one metal component is in combination with at least one of yttria, alumina, zirconia, boron or carbon.

5. The coating of claim 2 wherein the particulate material has a particle size of 5 to 250 μm.

6. The coating of claim 2 wherein the particulate material has a particle size of 40 to 125 μm.

7. The coating of claim 1 wherein the bond layer has a thickness of 5 to 300 μm.

8. The coating of claim 1 wherein the ceramic powder making up the porous layer is at least one metal compound selected from the group of oxides, nitrides, carbides and borides.

9. The coating of claim 1 wherein the ceramic powder making up the porous layer is at least one metal compound selected from the group of alumina, titania, silica, stabilized zirconia, silicon nitride, silicon carbide and tungsten carbide.

10. The coating of claim 1 wherein the ceramic powder making up the porous layer is at least one mineral compound selected from the group of ilmenite, rutile or zircon.

11. The coating of claim 1 wherein the organic polymer is thermoplastic material selected from at least one of the group of polystyrene, styrene-acrylonitrile, polymethacrylates, polyesters, polyamides, polyamide-imides, and PTFE.

12. The coating of claim 9 wherein the size of the ceramic particle size is in the range of 20 μm to 400 μm.

13. The coating of claim 9 wherein the size of the ceramic particle size is in the range of 5-300 μm.

14. The coating of claim 11 wherein the polymer particle size is in the range of 20-400 μm.

15. The coating of claim 11 wherein the polymer particle size is in the range of 45-300 μm.

16. The coating of claim 1 wherein the porous coating has a thickness of from 50-600 μm.

17. A process of providing a coating on the surface of a metal transport and holding apparatus comprising the steps of:
applying a bond layer to the metal surface of an article;
co depositing a layer of ceramic and organic polymer particulate material onto the bond coat; and
heating the layer of ceramic and organic polymer material to bind the ceramic material and remove the polymer material to leave a porous layer of ceramic material.

18. The process of claim 17 wherein the step of heating to bind the ceramic particles and remove the polymer material is conducted at a temperature above the thermal decomposition temperature of the polymer material and up to 550° C.

19. The process of claim 17 wherein the bond layer is formed of a particulate material having at least one metal component in a metallic, intermetallic, oxide, clad or alloyed form.

20. The process of claim 19 wherein the at least one metal component in the bond layer is selected from the group consisting of molybdenum, nickel, aluminium, chromium, cobalt, yttrium and tungsten.

21. A metal holding and transfer apparatus comprising:
an article formed of a metal substrate for contacting molten metal,
the substrate having a multilayer coating comprising an initial bond layer applied to the surface of the article, and
a porous insulating ceramic layer formed by the co deposition of powders of ceramic particles and polymer and the heating of the co deposited layer to bind the ceramic particles and remove the polymer.

22. The apparatus of claim 21 wherein the bond layer has a thickness of 5 to 300 μm and the porous ceramic insulating layer has a thickness of 50 to 600 μm.

23. The metal holding and transport apparatus of claim 21 wherein the bond layer is formed of a particulate material applied to the metal substrate, the particular material having at last one metal component in a metallic, intermetallic, oxide, clad or alloyed form.

24. The metal holding and transport apparatus of claim 23 wherein at least one metal component in the bond layer is selected from the group consisting of molybdenum, nickel, aluminium, chromium, cobalt, yttrium and tungsten.
